(19) United States
(12) Patent Application Publication
(10) Pub. No.: US 2017/0247835 A1
(43) Pub. Date: Aug. 31, 2017

(54) METHOD FOR PRECIPITATING LIGNIN FROM ORGANOSOLV PULPING LIQUORS

(71) Applicants: FRAUNHOFER-GESELLSCHAFT ZUR FÖRDERUNG DER ANGEWANDTEN FORSCHUNG E.V., München (DE); MAX PLANCK GESELLSCHAFT ZUR FÖRDERUNG DER WISSENSCHAFT E.V., München (DE)

(72) Inventors: Moritz LESCHINSKY, Leipzig (DE); Gerd UNKELBACH, Leipzig (DE); Peter SCHULZE, Pömmelte (DE); Heike LORENZ, Magdeburg (DE); Andreas SEIDEL MORGENSTERN, Magdeburg (DE)

(73) Assignees: FRAUNHOFER-GESELLSCHAFT ZUR FÖRDERUNG DER ANGEWANDTEN FORSCHUNG E.V., München (DE); MAX PLANCK GESELLSCHAFT ZUR FÖRDERUNG DER WISSENSCHAFT E.V., München (DE)

(21) Appl. No.: 15/519,785

(22) PCT Filed: Oct. 19, 2015
(86) PCT No.: PCT/EP2015/074187

§ 371 Date: Apr. 17, 2017

(30) Foreign Application Priority Data
Oct. 20, 2014 (DE) 10 2014 221 238.3

(51) Int. Cl. D21C 11/00; D21C 3/20; C07G 1/00

(52) U.S. Cl. CPC D21C 11/0007; C07G 1/00; D21C 3/20

(57) ABSTRACT

The present invention relates to a method for precipitating lignin from organosolv pulping liquors. For this purpose, the organosolv pulping liquor is introduced as a precipitation medium in an already existing aqueous dispersion of lignin particles or a filtrate of an aqueous dispersion of lignin particles, wherein a separate, lignin-containing phase in a dispersed state is produced.

The present invention relates to a method for precipitation of lignin from organosolv pulping liquors. The organosolv pulping liquor is hereby introduced into an already existent aqueous dispersion of lignin particles or into a filtrate of an aqueous dispersion of lignin particles as precipitant, whereby a separate, lignin-comprising phase in dispersed state is produced.

The use of renewable raw materials is of increasing interest for industry in view of the finite nature of fossil resources. Lignocellulose biorefining could in future deliver a series of products by pulping of wood biomass. In addition to cellulose and hemicellulose, lignin belongs to the main components of wood biomass and can be used for example as aromatic source or in materials. Native lignin, as present in lignocellulose, can be described as a three-dimensionally branched biopolymer which is, depending on the plant, composed of different proportions of the three monomers, coumaryl-, coniferyl- and sinapyl alcohol. The biomass pulping is necessary in order to separate the components of the lignocellulose from each other and can be realized inter alia by organosolv pulping. During the pulping, the original lignin structure is partially degraded and, depending on the pulping conditions, split up into fragments of various sizes which are soluble in the pulping solution.

In the case of organosolv pulping, lignocellulose is pulped in alcohols, such as ethanol, methanol or longer-chain alcohols, organic acids, such as acetic acid or formic acid, ketones and also mixtures of these solvents and mixtures with water at temperatures around 150-200° C. The use of catalysts, such as for example sulphuric acid, sulphur dioxide, sodium hydroxide or hydrogen chloride, is likewise possible. Lignin and hemicellulose are thereby solvolysed, and are present in a dissolved form in the solvent mixture, the pulping liquor, after the pulping. The cellulose is separated as a fibre fraction. The lignin can be precipitated in the pulping liquor by reducing the organic solvent content since it is practically insoluble in water. This can be realized for example by dilution of the pulping liquor with water or by evaporation of the organic solvent. In the case of dilution precipitation by simple dilution of the pulping liquor with water, generally no scaling is produced in the apparatus and the lignin forms a very fine precipitate which is often difficult to filter, dry and handle as bulk material. For an economic operation, the organic solvent must be recycled, for which reason it must be separated for example by distillation. During lignin precipitation by dilution, the mass flow of the pulping liquor is for example tripled and, after filtration, a relatively large amount of energy must be applied for separation of the solvent. In the case of evaporation precipitation in which the solvent is evaporated directly out of the pulping liquor, usually a high degree of scaling is produced by liquefied lignin. Recycling of the solvent is obtained quasi in the evaporation precipitation, as a result of which evaporation precipitation must be preferred to dilution precipitation from economic points of view.

U.S. Pat. No. 3,585,104 describes a plant in which the hot pulping liquor is separated by multistage counterflow expansion evaporation into a quasi-molten lignin phase, an aqueous phase with dissolved hemicelluloses and a solvent-rich vapour phase. The heavy soft lignin phase can be obtained from the process by simple phase separation as viscous liquid. The soft lignin phase still comprises solvent residues which must be removed, for example by steam stripping.

Evaporation of the solvent from the soft lignin phase is, however, practically impossible according to this patent. The soft lignin would in addition solidify during evaporation of the solvent if it is not heated above its flowing temperature. Handling of the softened lignin is complex from a technical point of view and the additional steam stripping is energy-intensive.

U.S. Pat. No. 4,100,016 describes a plant in which the hot pulping liquor is subjected to an expansion evaporation. A part of the organic solvent thereby evaporates and the lignin precipitates. The obtained dispersion should, at low pressure, have a temperature of approx. 80° C. The dispersion passes subsequently into a steam-heated stripping column which operates at lower pressure in order to reduce the temperature of the dispersion and to avoid scaling of the column with lignin. In the stripping column, the organic solvent is completely evaporated. The lignin dispersion leaves the column at the bottom and is concentrated by means of a sedimentation tank and centrifuge to form a lignin dispersion with 30 to 40% lignin content.

Based on laboratory tests “flashing” of the pulping liquor should lead to high scaling of the plant, which requires redundancies in the plant and complex cleaning of the apparatus. During evaporation of the remaining solvent in a distillation column at low pressure, the result should be, based on laboratory tests, formation of a poorly controllable bubble column.

U.S. Pat. No. 8,528,463 B2 describes a plant for organosolv fractionation of lignocellulose. The lignin is obtained in four fractions with a different molecular weight. The first lignin fraction precipitates, after enzymatic hydrolysis and subsequent fermentation, into ethanol as hydrolysis residue. The other three fractions are contained in the pulping liquor. The hot pulping liquor passes into a first container in which lignin with a high molecular weight (HMW lignin) precipitates. The HMW lignin is separated by a suitable technique and the liquid phase passes into a second container in which it is diluted with water. The water originates from the bottom of a distillation column for solvent recovery. The produced lignin dispersion is filtered and the filtrate passes into the previously mentioned distillation column in which the solvent is evaporated. The lignin passes into a drier. A further lignin fraction precipitates out of the bottom product of the distillation column, after acetic acid had evaporated. The dilution precipitation with cool water according to this process leads, as a result of separate tests, to poorly filterable lignin with very small particles which are difficult to dry. The separation of lignin into various fractions requires a greater filtration complexity and hence results in higher costs. In addition, the already mentioned economic disadvantages of dilution precipitation exist since the mass flow of the pulping liquor is multiplied and, after filtration of the lignin, a relatively large amount of energy must be applied for the separation of the solvent from the filtrate.

As shown above, both the stripping of organic solvents from the organosolv pulping liquor and precipitation of lignin from the organosolv pulping liquor by means of water is hence problematic since, on the one hand side, lignin particles are obtained which can only be processed with difficulty or, on the other hand side, the method is uneconomical.

It is hence the object of the present invention to provide a novel method which addresses the previously mentioned problems. The novel method should be distinguished, on the one hand, by the fact that the thus produced lignin particles have an extremely high quality and, on the other hand, by the fact that the method can be carried out extremely economically.

This object is achieved by the features of patent claim 1 and also by the lignin particles according to patent claim 15. The respectively dependent patent claims thereby represent advantageous developments.

The present invention hence relates, according to a first aspect, to a method for precipitation of lignin from an organosolv pulping liquor comprising a mixture of water and at least one organic solvent and also lignin which is dissolved in the mixture, in which the organosolv pulping liquor is introduced into an aqueous dispersion of lignin particles or into a filtrate of an aqueous dispersion of lignin particles, the at least one organic solvent being removed at least partially from the mixture produced by the introduction of the organosolv pulping liquor into the aqueous dispersion so that the content of the at least one organic solvent in the mixture is kept lower than in the organosolv pulping liquor and in which from the dissolved lignin a separate lignin-comprising phase is formed which is present dispersed in the mixture in a dispersed state.

The term lignin is thereby understood, according to the invention, such that unmodified lignin and also precipitable lignin derivatives are included.

The organosolv pulping liquors which can be used according to the present invention can thereby be produced from any raw materials. It is crucial merely that the organosolv pulping liquors comprise lignin and hence originate from a lignin-comprising source. Sources, given merely by way of example, from which the organosolv pulping liquors can be produced are deciduous wood, coniferous wood, but also straw and grasses. The present invention is of course not restricted to the previously mentioned lignin sources.

The organosolv pulping liquor can thereby comprise, in addition to the above-mentioned minimum components, also other components, such as e.g. sugar, proteins or components usually produced during organosolv pulping.

In contrast to the initially presented methods for the production of precipitated lignin, the present invention is based on using in fact an aqueous dispersion of lignin particles or a filtrate of an aqueous dispersion of lignin particles, instead of water, as precipitant, and removing the solvent at least partially from the dispersion, at the same time. The aqueous dispersion of lignin particles which are used in the method according to the invention can be produced for example initially by an organosolv pulping liquor, which is also to be used in the method according to the invention, being diluted with water until lignin particles are firstly precipitated. A corresponding filtrate of a precipitated organosolv pulping liquor produced in this way can likewise be used as precipitant in the method according to the invention.

With the procedure according to the invention it can be established surprisingly that, on the one hand, lignin particles of high quality, in particular with a precisely defined and essentially homogeneous particle diameter distribution, can be produced, on the other hand, an extremely economical procedure can be ensured with the method according to the invention since using an unnecessarily large quantity of water during precipitation of the lignin particles, which would have to be separated again subsequently in a complex manner, is avoided.

The advantages of the method according to the invention relative to current ones for lignin precipitation are in particular:
providing a process window with temperature and solvent content of the dispersion
avoiding scaling in the precipitation reactor
improving the filterability by enlarging the particles
controlled precipitation and solvent recovery possible in one apparatus
no or essentially fewer additional media required for dilution, consequently considerable energy savings in the subsequent solvent recovery.

In addition, the organic solvent which is contained in the organosolv pulping liquor, is at least partially separated from the mixture produced during the precipitation process so that the concentration or content of the organic solvent in the aqueous dispersion or in the filtrate of this dispersion is kept lower than in the organosolv pulping liquor.

A preferred embodiment provides that the content of the at least one organic solvent in the mixture is adjusted to a predetermined threshold value and the introduction of the organosolv pulping liquor and/or the at least partial removal of the at least one organic solvent is controlled such that the threshold value is exceeded or fallen below at most by 10%, preferably at most 5%, particularly preferably at most 2%.

With such a measure, the optimal content of the organic solvent in the mixture is maintained so that excellent and complete formation of the separate lignin-comprising phase is ensured. By controlling the introduction of the organosolv pulping liquor or controlling the partial removal of the at least one organic solvent from this mixture, the threshold value can be kept as constant as possible, preferably by a combination of control of both measures.

In particular the threshold value of the content of the at least one organic solvent is adjusted to 0.01 to 40% by weight, preferably 1 to 15% by weight, particularly preferably 5 to 10% by weight.

According to a further preferred embodiment, the at least partial removal of the at least one organic solvent is effected by means of distillation, preferably by means of distillation under pressure reduced relative to normal conditions, in particular at pressures between 0.1 and 1000 mbar, particularly preferably between 100 and 500 mbar, and/or by membrane filtration.

The separate dispersed lignin-comprising phase preferably comprises solid lignin particles and/or liquid lignin droplets. According to a particularly preferred embodiment, the dispersed lignin-comprising phase consists of solid lignin particles or liquid lignin droplets.

The introduction of the organosolv pulping liquor into the aqueous dispersion or into the filtrate of the aqueous dispersion and/or the at least partial removal of the at least one organic solvent is effected preferably in fed-batch mode, i.e. quasi continuously or continuously.

During the introduction of the organosolv pulping liquor into the originally present aqueous dispersion of lignin particles or into the filtrate of the aqueous dispersion, the organosolv pulping liquor is adjusted preferably to a temperature of 20 to 200° C., preferably 50 to 150° C., particularly preferably of 60 to 100° C. The same applies likewise for the further introduction of the organosolv pulping liquor into the once-produced mixture which is produced upon the first introduction of the organosolv pulping liquor into the aqueous dispersion or into the filtrate of the aqueous dispersion.

The aqueous dispersion or the filtrate of the aqueous dispersion is preferably adjusted to a temperature of 20 to 100° C., more preferably 40 to 90° C., during the first introduction of the organosolv pulping liquor. The same temperature ranges are chosen likewise preferably for the mixture which is used from the introduction of the organosolv pulping liquor into the originally used aqueous dispersion or the filtrate thereof.

According to a further preferred embodiment, the content of the at least one solvent in the organosolv pulping liquor is from 10 to 90% by weight, preferably 30 to 70%, particularly preferably 40 to 60% by weight.

Likewise, it is advantageous if the content of the at least one organic solvent in the mixture produced by the introduction of the organosolv pulping liquor into the aqueous dispersion or into the filtrate of the aqueous dispersion is further reduced after completion of the precipitation, preferably by distillation of the at least one organic solvent and/or by means of membrane filtration.

By means of such a measure, the solvent content in the mixture can be further reduced and the solvent can be recovered. As a result, further economic advantages of the method control according to the invention are ensured. However, because of the already concluded precipitation, no quality loss in the already precipitated separate lignin-comprising phase thereby takes place.

A particularly preferred embodiment provides that, after completion of the precipitation and/or during precipitation, the median of the number-averaged particle size distribution of the dispersed lignin-comprising phase is increased by mechanical agitation and/or heating of the mixture above the softening point of the lignin.

In the case where the lignin particles are already present in solid form, an increase in temperature of the mixture can lead to the lignin particles being heated above the softening point of the lignin and the solid lignin particles being converted into a soft form or into liquid lignin particles. By means of preferably mechanical agitation, consolidation of the (small) lignin particles to form (larger) lignin particles can thereby be undertaken.

It is likewise preferred if the dispersed lignin-comprising phase is separated after completion of the precipitation and/or after changing the particle size distribution and/or after further reduction in the content of at least one solvent and/or after cooling the mixture below the softening temperature of the dispersed lignin phase, preferably by means of solid-liquid separation methods, in particular by filtration, sieving and/or centrifugation.

The at least one organic solvent is thereby selected preferably from the group consisting of alcohols, in particular ethanol, methanol, n-propanol, i-propanol, n-butanol, i-butanol, tert.-butanol; organic acids, in particular formic acid, acetic acid; ketones, in particular acetone and also mixtures or combinations hereof.

Ethanol is hereby particularly preferred.

Advantageously, the method is carried out in a container with an agitation option, which container includes a feed line for organosolv pulping liquor, an option for supply of the evaporation energy, a draw-off means for vapours of the at least one organic solvent and also at least one condenser, installed downstream of the draw-off means, for the at least one organic solvent and possibly also an outlet and preferably a heat exchanger in the outlet and/or a column in front of the vapour condenser.

The present invention likewise relates to lignin particles which are producible according to an above-presented method.

Preferably, the lignin particles are distinguished by a number-averaged particle diameter of 1 to 1,000 μm, preferably 10 to 100 μm.

The particle diameter of individual particles—or the weight-averaged particle diameter is thereby determined inline by means of microscopic image analysis and/or laser reflection measurement (Lasentec FBRM

V600VL System of Mettler Toledo). Likewise, determination can be effected according to 0. Monnier et al., described in Part. Part. Syst. Charact. 13 (1996) 10-17.

In particular, the lignin particles have an approximately or completely spherical shape. The lignin particles are hereby defined by an axis ratio according to the following formula:

$$\frac{{Σ}_{i = 1}^{n} {a}_{i} \text{:} {b}_{i}}{n}$$

wherein
aᵢ designates the smallest axis dimension of a two-dimensional projection of a lignin particle,
bᵢ the largest axis dimension of a two-dimensional projection of a lignin particle and
n the number of lignin particles of a particle sample,
wherein the axis ratio is >0.5, preferably >0.8.

Alternatively hereto, the lignin particles can be present also as agglomerate of primary particles, the respective primary particles also being able to have the previously mentioned condition of the axis ratios.

The present invention is examined in more detail with reference to the subsequent embodiments without restricting the invention to the illustrated special parameters.

The invention comprises an improved method for precipitation of lignin from organosolv pulping liquor. The process can be implemented semi-continuously or preferably continuously. The precipitation is thereby effected by (semi-)continuous metering of organosolv pulping liquor into a lignin dispersion with a solvent content and a temperature according to the invention. This lignin dispersion can be obtained at the beginning by mixing of pulping liquor with water or, in the (semi-) continuous operation, by retention of already produced lignin dispersion. Examples of values according to the invention of solvent content and temperature can be deduced from the embodiments. The solvent content in the dispersion is kept constant by means of (semi-) continuous evaporation of the solvent supplied (by the pulping liquor). The temperature of the lignin dispersion is adjusted by the pressure above the dispersion and kept constant. Heating of the dispersion can be effected indirectly by heat exchangers or directly by steam introduction inter alia. The resulting solvent-water-vapour can be discharged directly and condensed or rectified firstly and then condensed. The resulting lignin dispersion can be discharged (semi-) continuously and filtered after cooling and/or further reduction in the solvent content in a second plant.

The precipitation of the lignin, the adjustment of the particle size distribution and the evaporation of the solvent can take place simultaneously in one apparatus without formation of scaling, which represents an improvement relative to the state of the art. Adjustment of the particle size distribution can be effected before, during or after evaporation of the solvent and, if required, independently of the evaporation of the solvent.

Before filtration, the dispersion must be cooled, in the case of a sufficiently small solvent content, only in order to increase the viscosity of the lignin. In the case of a higher solvent content, evaporation must take place further in a second apparatus (for example similar in construction to the first) by reducing the pressure and possibly heat supply before the dispersion can pass onto the filtration.

The present invention is explained in more detail with reference to the subsequent figures without restricting the invention to the special parameters in the figures.

There are shown therein:

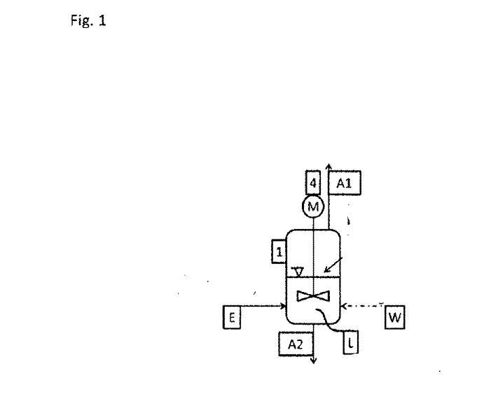

FIG. 1 a first device for implementing the method according to the invention,

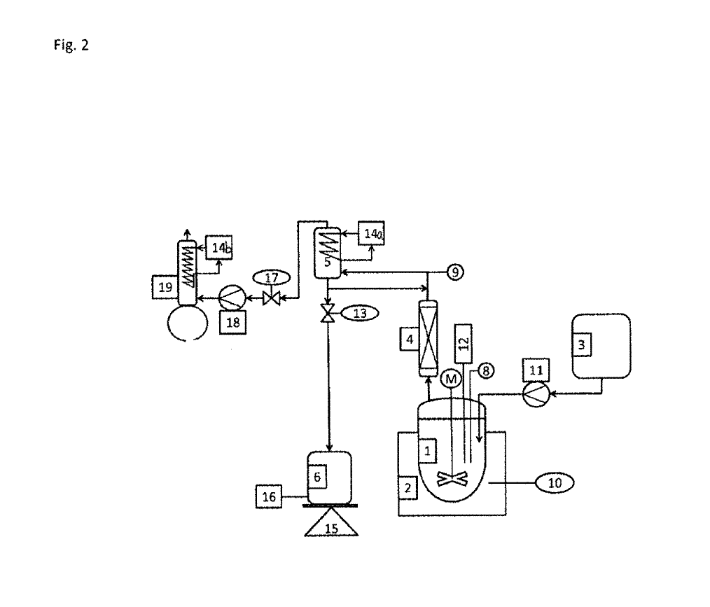

FIG. 2 a second device for implementing the method according to the invention,

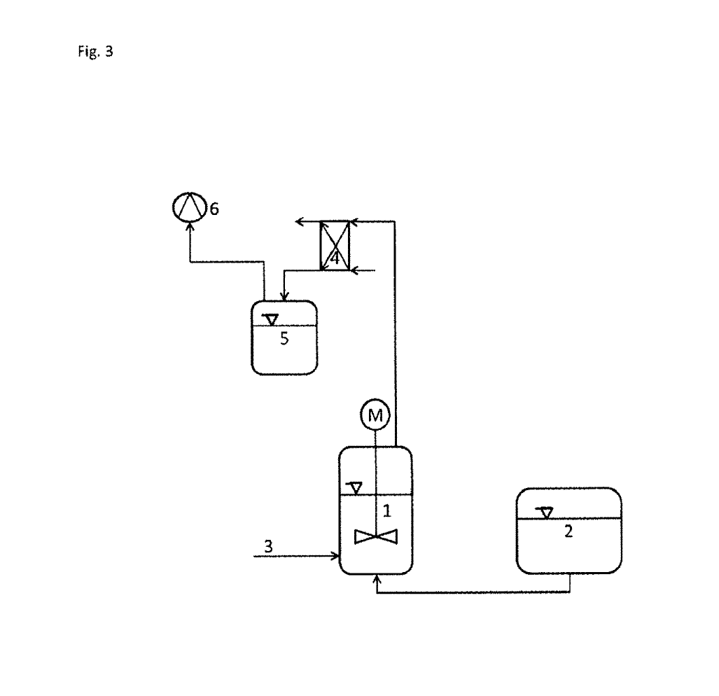

FIG. 3 a third device for implementing the method according to the invention,

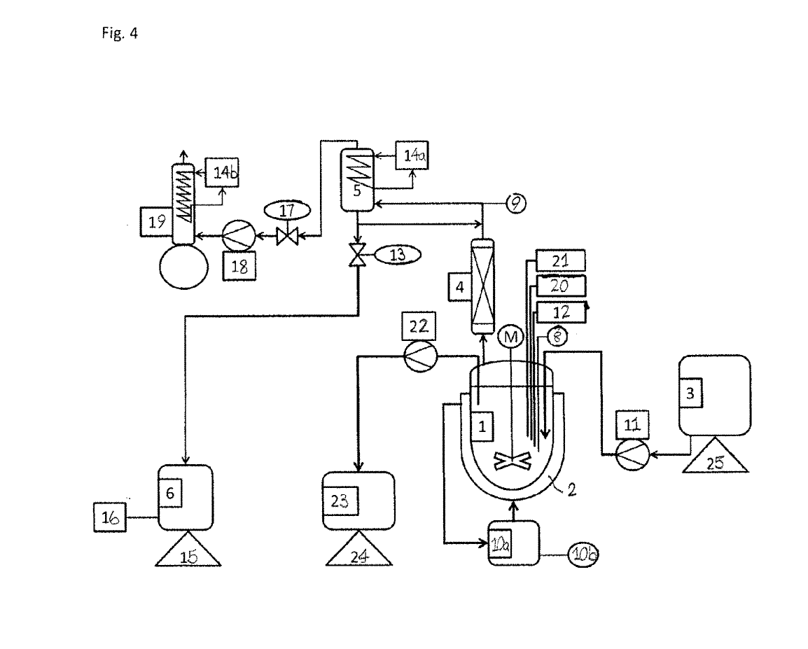

FIG. 4 a fourth device for implementing the method according to the invention,

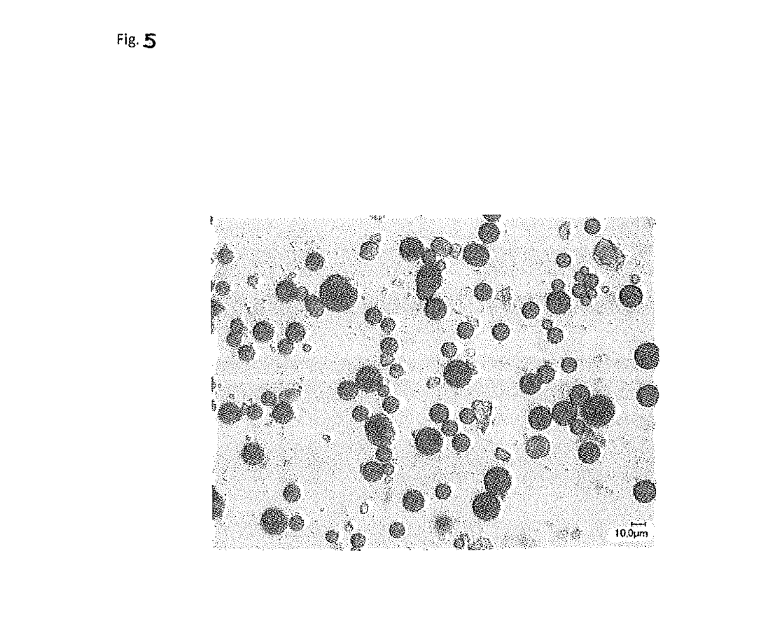

FIG. 5 a microscopic photograph of lignin particles produced according to the invention, and also

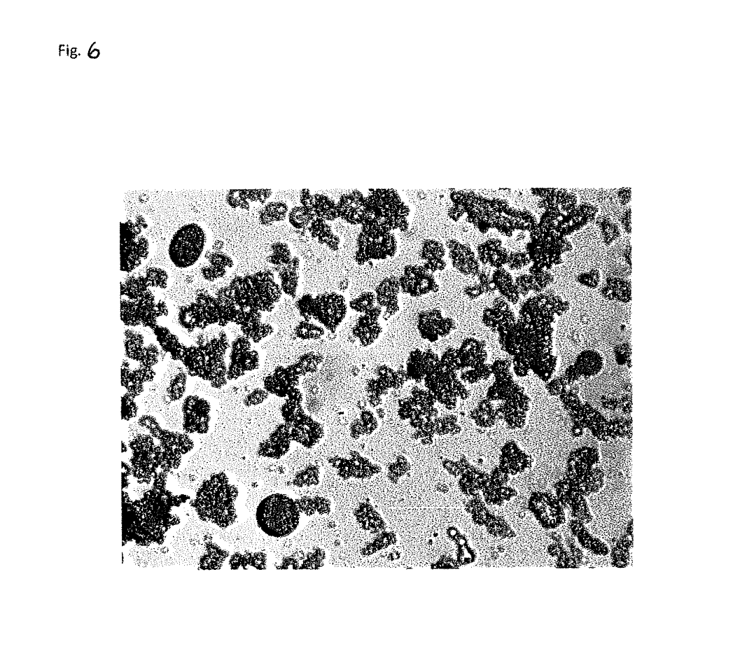

FIG. 6 a microscopic photograph of a further lignin fraction produced according to the invention,

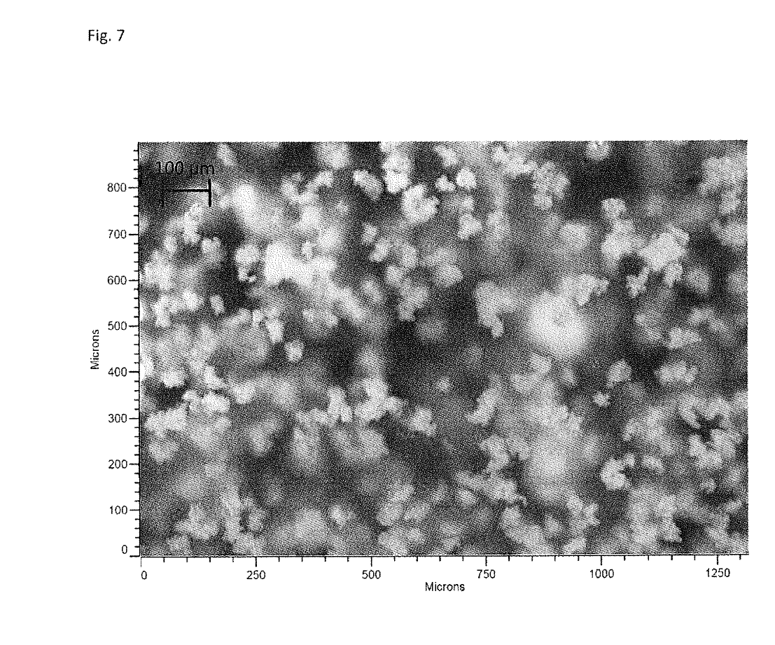

FIG. 7 a microscopic photograph of a further lignin fraction produced according to the invention.

FIG. 1 shows a first apparatus, by way of example, for implementing the method according to the invention. An agitated tank 1 with a mechanical agitator in which a dispersion of lignin particles or a filtrate of a dispersion of lignin particles L are present is illustrated. Via an inlet E, organosolv pulping liquor, in particular from a lignocellulose pulping method, is introduced into the agitated tank 1. Upon entry of the organosolv pulping liquor into the agitated tank 1, mixing of the organosolv pulping liquor with the dispersion of lignin particles present or the filtrate of the dispersion takes place. Because of the fact that the concentration of organic solvent in this dispersion or in the filtrate is less than an organosolv pulping liquor, precipitation of the dissolved lignin from the organosolv pulping liquid takes place. The agitated tank 1 can be temperature-controlled or cooled via a direct or indirect heat supply W.

Via a draw-off means A1, a distillation of the at least one solvent can be ensured, for example via an applied partial vacuum or a reduced pressure. The mixture produced during the precipitation process can be discharged via a second outlet A2.

FIG. 2 shows a further device, given by way of example, for implementing the method according to the invention. This device also includes an agitated tank 1 for lignin precipitation with a mechanical agitator M. The agitated tank 1 comprises in addition a jacket 2 via which the agitated tank 1 can be heated or cooled. The temperature of the jacket can thereby be monitored for example by means of a temperature sensor 10. The organosolv pulping liquor can thereby be stored for example in a storage container 3 and fed into the agitated tank 1 via a pump 11. In the agitated tank, a dispersion of lignin particles or a corresponding filtrate is thereby introduced as precipitant. The temperature course of the mixture is monitored by means of a temperature sensor 8 in the agitated tank. The particle size distribution of the lignin in the dispersion can be tracked via a probe 12, in particular a probe with which an inline laser reflection measurement can be implemented. The solvent which is contained in the organosolv pulping liquor, in particular ethanol, is thereby drawn off via a draw-off means on the agitated tank which opens into a condenser 5. A rectification column 4 is connected in front of the condenser 5. The temperature of the gas flow can be monitored by means of a temperature sensor 9. The condenser 5 can be supplied with a cooling medium 14a. For distillation and condensation of the solvent via the described condenser 5, for example a low pressure which is produced by a vacuum pump 18 can act on the entire agitated tank 1. The low pressure can be controlled for example by a control valve 17. For determining the quantity of drawn-off solvent, the distillate can be for example weighed, in particular via a weighing scales 15 for the distillate, with which the weight of the distillate accumulating in the distillation container 6 is determined. The inflow to the distillation container 6 can thereby be controlled by means of a valve 13. Via a density measuring device or a refractometer 16 for the distillate, the ethanol content of the distillate and hence the total quantity of the separated ethanol can be determined. Subsequent to the vacuum pump 18, a separation device 19 for any possibly still contained solvent, for example ethanol, can be connected, in particular a cooling device, in which ethanol from the discharged gaseous flows can be separated by means of a cooling medium 14b.

FIG. 3 shows a further device for implementing the method according to the invention. This device also comprises an agitated tank 1 for lignin precipitation, which can have for example also a temperature- and pressure measuring device. Organosolv pulping liquor from a storage container 2 for pulping liquor is fed to the agitated tank. This container can be provided with a weighing scales so that the absolute quantity of organosolv pulping liquor that has been fed and the rate thereof can be determined. Via a feeding option 3, hot steam (for example with a pressure of 230 mbar absolute and 63° C.) can be fed into the agitated tank 1. The pressure in the agitated tank has been adjusted in this example to 100 mbar. However, also gaseous products, in particular the solvent (for example ethanol) from the resulting mixture in the agitated tank 1 can be discharged and condensed in the condenser 4. The condensate can be collected for example in a collection vessel 5, for example a distillate container with temperature- and level measurement. The distillation of the solvent can be assisted via a vacuum pump 6 with pressure regulation.

FIG. 4 shows a further device for implementing the method according to the invention which follows the construction of the device presented in FIG. 2. Identical reference numbers thereby designate identical components. The device according to FIG. 4 is suitable in particular for implementing a continuous precipitation process. In addition to the components shown in FIG. 2, the device according to FIG. 4 comprises a probe 21 in the agitated tank, with which probe the ethanol content of the dispersion can be monitored. This can be for example a calibrated ATR-FT-MIR probe (attenuated total reflection-FT-MIR). Likewise comprised is a videomicroscope probe 20 with which the shape and size of the lignin particles in the dispersion can be observed. In addition, the device comprises a discharge option with which the lignin dispersion can be removed from the agitated tank 1. A pump 22 is provided for this purpose, with which pump the lignin dispersion can be pumped into a dispersion container 23. The discharged quantity of dispersion can thereby be monitored by means of a weighing scales 24. Likewise comprised is a weighing scales 25 with which the introduced organosolv pulping liquor from the storage container 3 can be determined and monitored.

The present invention is described in more detail with reference to the subsequent embodiments without restricting the invention hereto.

### Embodiment 1 (Laboratory Scale)

Apparatus and Chemicals:

The organosolv pulping liquor used (made of deciduous beech) is composed on average as follows: 47% w/w ethanol, 47% w/w water, 4% w/w carbohydrates, 2% w/w lignin.

The experimental setup can be deduced from FIG. 2.

In the agitated tank 1, approx. 150 g lignin dispersion with approx. 10% w/w ethanol was introduced by mixing water (80% w/w) and pulping liquor (20% w/w). The pressure in the agitated tank was thereby adjusted to 100 mbar. The lignin dispersion was adjusted via heating 2 to boiling temperature of the dispersion of approx. 42.5° C. Distillation with complete reflux was effected until the vapour temperature 9 was constantly 29.5° C. Upon reaching the constant temperature, a thermodynamic equilibrium was set in the rectification column 4. The distillate flow was adjusted by means of reflux valve 13 to approx. 0.5 g distillate/min so that the vapour temperature remained constant in order to obtain a constant ethanol concentration in the distillate. Thereafter, the pulping liquor was supplied at approx. 1.2 g/min from the storage container 3, the dispersion temperature in the agitated tank 1 hereby remained constant, with which a constant ethanol concentration in the lignin dispersion was obtained. After metered addition of 283 g pulping liquor, the further addition was stopped since the maximum level in the agitated tank was reached. Further evaporation of ethanol or of an aqueous ethanol mixture was effected until the vapour temperature of water (45° C.) was approximately reached and an ethanol concentration was set in the lignin dispersion of less than 1% by weight. Thereafter, the pressure was raised to ambient pressure. Short heating of the lignin dispersion in the agitated tank 1 was effected to approx. 75° C. in order to increase the median of the lignin particle size distribution and to obtain approximately spherical lignin particles. Finally, cooling of the dispersion to approx. 20° C. and filtration of the dispersion was effected in order to separate the produced lignin particles.

Results and Conclusions:

As can be seen in FIG. 4, this experiment succeeded in producing relatively large spherulitic and readily filterable lignin particles. A negligibly small quantity of lignin scaling was formed above the liquid level in the reactor.

The semi-continuous evaporation precipitation and adjustment of the particle size were realized one by one in this experiment. Both steps could also take place at the same time or the adjustment of the particle size before the evaporation. The experiment could be implemented continuously by discharging the dispersion.

### Embodiment 2 (Pilot Scale)

Apparatus and Chemicals:

The organosolv pulping liquor used (made of deciduous beech) is composed on average as follows: 50% w/w ethanol, 44% w/w water, 3% w/w carbohydrates, 3% w/w lignin.

The schematic experimental setup can be deduced from FIG. 3.

Introduction of approx. 150 kg lignin dispersion (with approx. 10% w/w ethanol) was effected by mixing water (80% w/w) and pulping liquor (20% w/w) in the agitated tank 1. The pressure in the agitated tank was thereby adjusted to 175±25 mbar. Heating 3 of the lignin dispersion was effected with a constant quantity of hot steam. A metered addition of approx. 50 kg/h pulping liquor was effected at the beginning of the boiling of the dispersion so that the dispersion temperature remained constant at a temperature of approx. 51±3° C. As a result, it was ensured that the ethanol concentration in the lignin dispersion likewise remained constant.

The metered addition of pulping liquors from the supply vessel 2 was stopped after approx. 100 kg since the maximum level in the agitated tank 1 was reached. Subsequently, there was effected a slow reduction in pressure to 100 mbar in order to achieve evaporation of ethanol/water until the vapour temperature of water (45° C.) was approximately reached and hence the ethanol concentration in the lignin dispersion of less than 1% w/w was reached. Finally filtration of the dispersion was effected.

In this experiment on pilot scale, relatively large and readily filterable lignin particles in the form of agglomerates were successfully produced, as can be detected in FIG. 5. Above the liquid level in the reactor, negligible scaling was formed. The semi-continuous precipitation and adjustment of the particle size were effected at the same time in this experiment. The conditions were close to the optimum for forming spherulitic particles.

### Embodiment 3 (Continuous Precipitation on Laboratory Scale)

Apparatus and Chemicals:

The organosolv pulping liquor used (made of coniferous spruce) was composed on average as follows: 55% w/w ethanol, 37% w/w water, 4.5% w/w lignin, 2% w/w (oligo-)saccharides, 1.5% w/w carboxylic acids.

The schematicexperimental setup can be derived from FIG. 4.

Implementation:

Preliminary study for determining the process parameters:

In the agitated 1 litre jacketed reactor 1, 821 g water and 159 g pulping liquor were mixed together for the start-up dispersion. The ethanol content of the dispersion was monitored with a calibrated ATR-FT-MIR (Attenuated Total Reflection-FT-MIR) probe 21 and adjusted to approx. 7.5% w/w. The start-up dispersion was heated with the heating thermostat 10a at 0.5 K/min. The particle size distribution of the lignin was thereby monitored with an FBRM probe 12 (Focused Beam Reflectance Measurement, Lasentec/Mettler Toledo). With the help of a videomicroscope probe 20, shape and size of the lignin particles in the dispersion were observed. The size and shape of the lignin particles changed significantly above a characteristic temperature. This temperature (measured with PT100,7) was assumed as softening temperature of the lignin and was approx. 53.5° C. From the softening temperature, 5-10 K were subtracted in order to derive the temperature for the continuous precipitation process. From the boiling diagram for ethanol and water, the process pressure of 125 mbar absolute was obtained for the continuous precipitation.

Continuous Precipitation:

The process pressure was adjusted by the vacuum pump 18 and the vacuum control valve 17. The heating medium in the heating jacket 2 was adjusted via the heating thermostat 10a, which is monitored by means of a temperature sensor 10b, to a temperature of approx. 10 K above the process temperature and the dispersion was heated to approx. 45° C. boiling temperature. The distillation column 4 was equilibrated with a closed distillate valve 13 until the vapour temperature 9 was constantly approx. 33.5° C. The vapour was condensed in the cooler 5 with cooling medium of the cooling thermostat 14a. With the feed pump 11, approx. 3 g/min pulping liquor was then conveyed continuously out of the pulping liquor container 3 into the agitated reactor 1. The conveyed quantity was detemined by weighing scales 25. The distillate valve 13 was opened at the same time in order to distil the ethanol of the metered-in pulping liquor and to keep the ethanol content in the dispersion constant. The distillate was collected in the distillate container 6 and weighed with a weighing scales 15. The distillate valve was adjusted such that the distillate comprised 80-90% w/w ethanol. The ethanol content was monitored via the vapour temperature 9 and with a density measurement 16. The resulting lignin dispersion was conveyed with the dispersion pump 22 out of the agitated reactor 1 into the dispersion container 23. The quantity of the dispersion is determined and monitored by means of a weighing scales 24. The conveying power was adjusted such that the sum of the masses of the distillate and of the dispersion was equal to the mass of the metered-in pulping liquor. After more than 900 g of pulping liquor had been added and the pulping liquor container was empty, the process was terminated. The heating thermostat was switched off, the plant was vented and the dispersion was pumped completely out of the agitated reactor 1 into the dispersion container 23.

The dispersion was subsequently filtered at room temperature, an average filter cake resistance of 2.9*10¹² m⁻² was determined.

Results and Conclusions:

This experiment succeeded in precipitating lignin continuously and in producing at the same time relatively large and readily filterable lignin particles in the form of agglomerates (FIG. 7). The filter cake resistance of 2.9*10¹² m⁻² has to be considered good if at 10*10¹⁰m⁻² excellent filterability and at 10*10¹⁶ m⁻² very poor filterability is present. A preliminary study for determining the optimum process parameters could be successfully applied. Above the liquid level in the reactor, only a small amount of lignin scaling was formed because of the higher ethanol concentration in the vapour phase (compared to the liquid phase).

1-18. (canceled)

19. A method for precipitating lignin from an organosolv pulping liquor comprising a mixture of water, at least one organic solvent and lignin which is dissolved in the mixture, the method comprising:
introducing the organosolv pulping liquor into an aqueous dispersion of lignin particles or into a filtrate of an aqueous dispersion of lignin particles, and
removing the at least one organic solvent at least partially from the mixture produced by introducing the organosolv pulping liquor into the aqueous dispersion so that the content of the at least one organic solvent in the mixture is kept lower than in the organosolv pulping liquor,
wherein a separate lignin-comprising phase, which is present in the mixture in a dispersed state, is formed from the dissolved lignin.

20. The method according to claim 19, wherein the content of the at least one organic solvent in the mixture is adjusted to a predetermined threshold value and the introduction of the organosolv pulping liquor and/or the at least partial removal of the at least one organic solvent is controlled such that the threshold value is exceeded or fallen short of at most by 10%.

21. The method according to claim 20, wherein the threshold value of the content of the at least one organic solvent is adjusted to 0.01 to 40% by weight.

22. The method according to claim 19, wherein at least partial removal of the at least one organic solvent is effected by distillation.

23. The method according to claim 19, wherein the dispersed lignin-comprising phase comprises solid lignin particles and/or liquid lignin droplets, or consists thereof.

24. The method according to claim 19, wherein the introduction of the organosolv pulping liquor into the aqueous dispersion or into the filtrate of the aqueous dispersion and/or the at least partial removal of the at least one organic solvent is realized in fed-batch mode or continuously.

25. The method according to claim 19, wherein, during the introduction into the aqueous dispersion or into the filtrate of the aqueous dispersion or into the mixture, the organosolv pulping liquor is adjusted to a temperature of 20 to 200° C.

26. The method according to claim 19, wherein the aqueous dispersion or the filtrate of the aqueous dispersion or the mixture is adjusted to a temperature of 20 to 100° C.

27. The method according to claim 19, wherein the content of the at least one organic solvent in the organosolv pulping liquor is from10 to 90% by weight.

28. The method according to claim 19, wherein the content of the at least one organic solvent in the mixture produced by the introduction of the organosolv pulping liquor into the aqueous dispersion or into the filtrate of the aqueous dispersion is further reduced after completion of the precipitation.

29. The method according to claim 19, wherein, after completion of the precipitation and/or during precipitation, the median of the number-averaged particle size distribution of the dispersed lignin-comprising phase is increased by mechanical agitation and/or heating of the mixture above the softening point of the lignin.

30. The method according to claim 19, wherein the dispersed lignin-comprising phase is separated after completion of the precipitation and/or after changing the particle size distribution and/or after further reduction in the content of at least one solvent and/or after cooling the mixture below the softening temperature of the dispersed lignin phase.

31. The method according to claim 19, wherein the at least one organic solvent is selected from the group consisting of alcohols, organic acids, ketones, and mixtures thereof.

32. The method according to claim 19, wherein the method is carried out in a container with an agitation option which comprises a feed line for organosolv pulping liquor, an option for supplying the evaporation energy, a draw-off means for vapours of the at least one organic solvent, an at least one condenser installed downstream of the draw-off means for the at least one organic solvent, and optionally an outlet.

33. Lignin particles produced according to the method of claim 19.

34. The lignin particles of claim 33, whose number-averaged particle diameter is 1 to 1,000 μm.

35. The lignin particles of claim 33, wherein the lignin particles have an approximately or completely spherical shape and are defined by an axis ratio according to the formula:
$$\frac{{Σ}_{i = 1}^{n} {a}_{i} \text{:} {b}_{i}}{n}$$
wherein
aᵢ designates the smallest axis dimension of a two-dimensional projection of a lignin particle,
bᵢ the largest axis dimension of a two-dimensional projection of a lignin particle,
n the number of lignin particles of a particle sample, and wherein the axis ratio is >0.5.

36. The lignin particles according to claim 33, wherein the lignin particles represent an agglomerate of primary particles, the primary particles having an axis ratio >0.5.
